(19) United States
(12) Patent Application Publication
(10) Pub. No.: US 2017/0030329 A1
(43) Pub. Date: Feb. 2, 2017

(54) POWER GENERATING APPARATUS

(71) Applicant: WHOOSH 2013 LIMITED, Sheffield, South Yorkshire (GB)

(72) Inventors: Brian Shawcross, Nottinghamshire (GB); Hugh David Facey, Sheffield, South Yorkshire (GB); Neil Clarke, Sheffield, South Yorkshire (GB)

(21) Appl. No.: 15/303,713

(22) PCT Filed: Apr. 10, 2015
(86) PCT No.: PCT/GB2015/000118

§ 371 Date: Oct. 12, 2016

(30) Foreign Application Priority Data
Apr. 15, 2014 (GB) 1406710.2
Sep. 18, 2014 (GB) 1416508.8
Apr. 8, 2015 (GB) 1505978.5

(51) Int. Cl. F03D 1/04; F03D 9/25; F03D 7/02; F03D 9/00

(52) U.S. Cl. CPC F03D 1/04; F03D 9/002; F03D 9/25; F03D 7/0224; F03D 7/0204; F05B 2240/133; F05B 2240/221; F05B 2220/706; F05B 2240/30; F05B 2270/402; F05B 2260/502; F05B 2260/404

(57) ABSTRACT

Power generating apparatus (10) comprises a housing (14) and a wind turbine (12) within the housing. The wind turbine comprises a plurality of rotatable turbine blades (66). The housing has a forward region (20) extending forwardly of the wind turbine, the forward region defining an inlet opening (22) for air, and a rearward region (24) extending rearwardly of the wind turbine, the rearward region defining an outlet opening for air.

This invention relates to power generating apparatus. Embodiments of this invention relate to wind turbine arrangements for generating power. This invention also relates to housings for wind turbines. This invention also relates to mounting frames for such housings. This invention also relates to base frames for such housings. This invention also relates to nose cones for such housings.

Wind turbines for generating electrical power are known. However, such turbines lack efficiency and therefore need to occupy large areas in order to generate the required amount of electricity.

According to one aspect of this invention, there is provided power generating apparatus comprising a housing and a wind turbine comprising a plurality of turbine blades rotatably mounted within the housing.

The power generating apparatus may comprise a wind turbine arrangement.

The housing may have an inlet and an outlet. The housing may have a forward region in which the inlet is defined. The housing may have a rearward region in which the outlet is defined. The housing may have a turbine holding region between the inlet and the outlet, the wind turbine being held within said turbine holding region.

The housing may taper inwardly from the inlet to the turbine holding region, and the housing may taper outwardly from the turbine holding region to the outlet. The forward region may have a frustoconical configuration. The rearward region may have a frustoconical configuration.

In the embodiment described herein, the inward tapering of the housing from the inlet to the turbine holding region causes the wind speed to increase from the inlet towards the turbine holding region. The outwardly tapering region from the wind turbine region to the outlet reduces pressure downstream of the wind turbine thus increasing air flow and turbine efficiency.

The housing may comprise a frame, which may be a skeletal frame, and may comprise struts or tubes. The struts or tubes may be formed of metal, such as aluminum. The housing may further include a skin, for example of a suitable plastics material disposed around the frame.

The housing may have a main axis and the inlet may be angled at an acute angle relative to the main axis. An upper region of the inlet may extend forwardly relative to a lower region of the inlet.

The wind turbine may comprise a turbine blade assembly. The turbine blade assembly may comprise a hub and a plurality of turbine blades extending radially from the hub. The hub may have a principal axis about which the turbine blades can rotate.

Each turbine blade may have a leading edge and a trailing edge. The pitch of each blade may vary from the leading edge to the trailing edge. The pitch may increase from the leading edge to the trailing edge.

The pitch of the leading edge may be between 0° and 10°. Desirably, the pitch of the leading edge is substantially 0°.

The pitch of the trailing edge may be between 50° and 60°. Desirably, the pitch of the trailing edge is substantially 57°.

As used herein, the pitch refers to the angle of attack of the turbine blade relative to the direction of flow of the wind. The pitch of each turbine blade, or of each portion of each turbine blade, is preferably selected to extract the maximum energy from the wind.

The turbine blade assembly may comprise a pitch control arrangement for controlling the pitch of the blades. The pitch control arrangement may be provided to reduce the pitch of the blades in high winds.

The pitch control arrangement may comprise a hinge arrangement for providing hinged attachment of each blade to the hub and urging arrangement for urging the blades to a first position of a desired pitch. The urging arrangement may be configured to apply an urging force onto the blades, whereby when the force of the wind on the blades exceeds said urging force, the blades move towards a second position, being a position of minimum pitch of the blades. The urging arrangement may be configured to allow the blades to move to an intermediate position between the first and second positions. Said intermediate position may be a position in a continuum of intermediate positions between the first and second positions, and is thereby determined by the force of the wind on the blades. Thus, in high winds, with the embodiments described herein, when the wind speed exceeds a predetermined first wind speed, the blades move to one of the intermediate positions between said first and second positions, thereby reducing the risk of damage to the blades. The urging arrangement may be configured so that when the wind speed exceeds a predetermined second wind speed, the blades may move to the second position.

The hinge arrangement may comprise a plurality of hinges. A respective hinge may be provided for each blade. The urging arrangement may comprise a plurality of springs, such as a plurality of tension springs. A respective spring may be provided for each blade.

The power generating apparatus may include a mounting arrangement for supporting the housing. The mounting arrangement may include a pivot arrangement about which the housing can revolve. Desirably, the housing can revolve in a substantially horizontal plane. The power generating apparatus may further include roller means arranged to facilitate revolving of the housing.

The power generating apparatus may comprise a housing assembly, comprising the housing and the wind turbine. The housing assembly has a centre of gravity, and the pivot arrangement may be provided at, or forwardly of, the aforesaid centre of gravity.

In one embodiment, the mounting arrangement may comprise a mounting frame upon which the housing is mounted. The mounting frame may comprise an upper frame section and a lower frame section. The housing may be seated within the mounting frame in engagement with the upper frame section and with the lower frame section.

The pivot arrangement may be provided on the mounting frame, whereby the mounting frame is rotatably movable about said pivot arrangement. The roller means may be provided on the mounting frame.

The mounting frame may comprise a lower frame section and an upper frame section. The housing may be seated on the mounting frame. The housing may engage at least one of the upper frame section and the lower frame section. The housing may engage both of the upper frame section and the lower frame section.

The lower frame section may comprise a plurality of elongate frame members. The lower frame section may be of a substantially rectangular, or a regular trapezium, configuration.

The upper frame section may comprise a pair of elongate support members arranged opposite one another on the lower frame section. The upper frame section may comprise spacer members to space the support members from the lower frame section.

The power generating apparatus may further include a base support structure, which may comprise a curved rail arrangement to accommodate the roller means. In one embodiment, the roller means are arranged to be received by the rail arrangement. The rail arrangement may be substantially semi circular or circular, to allow the mounting frame to effect a substantially circular or semi-circular rotation about the pivot.

The base support structure may include a co-operating arrangement to co-operate with the pivot arrangement. The pivot arrangement may comprise a projecting pivot member. The co-operating arrangement may comprise a co-operating member defining an aperture in which the pivot member can be received. It will be appreciated that, alternatively, the pivot member may be provided on the co-operating member and the aperture may be defined in the mounting frame.

In the embodiment described herein, the co-operating member comprises an elongate strut having two opposite ends. The rail may extend from one end of the co-operating member to the other.

In another embodiment, the pivot arrangement may be provided on the housing. A support apparatus may be provided, which may comprise the pivot arrangement. The support apparatus may engage the housing.

The power generating apparatus may comprise a driver for rotatably driving the wind turbine. The driver may comprise a wind reactive arrangement, said wind reactive arrangement being reactive to the force of the wind thereon. The wind reactive arrangement may comprise a vane, which may be mounted on the housing.

The vane may be configured to be deflected by the wind and orient the housing so that the inlet faces into the wind. The vane may extend rearwardly from the housing.

Alternatively, the driver may comprise the Divot arrangement located forwardly of the centre of gravity of the housing, whereby the wind deflects the housing so that the inlet faces into the wind.

The wind turbine may comprise a plurality of turbine blades mounted on a hub. The wind turbine may comprise between 40 and 56 turbine blades, which may be spaced regularly about the hub. In the embodiment described herein, the wind turbine may comprise substantially 48 turbine blades. The wind turbine may have a diameter of between 1 and 6 metres, desirably between 1.5 and 5 metres, more desirably between 2 and 4 metres. The wind turbine may have a diameter of substantially 2 metres. Alternatively, the wind turbine may have a diameter of substantially 4 metres.

The power generating apparatus may further include a support arrangement for supporting the wind turbine on the housing. The support arrangement may comprise a plurality of elongate support members, which may comprise elongate braces.

The support arrangement may include a nose assembly arranged adjacent the wind turbine blades. The nose assembly may be disposed upstream of the wind turbine blades. The nose assembly may comprise a nose cone.

The nose assembly may comprise a framework comprising a plurality of elongate members and a skin arranged over the elongate members. The elongate members may comprise elongate stays. The skin may be formed of a plastics material. The nose assembly may further include a central shaft, which may be mounted for rotation relative to the elongate members. The elongate members may include a holding portion, the shaft being held by the holding portion for rotation relative to the holding portion. The shaft may extend from the hub. The shaft may be fixedly attached to the hub.

The power generating apparatus may further include an electricity generating apparatus comprising a generator, which may be an alternator.

In one embodiment, the electricity generating apparatus may include a gearing arrangement connected to the wind turbine blades. The gearing arrangement may comprise a chain and sprocket wheel assembly.

The gear arrangement may comprise a first sprocket wheel directly driven by the turbine blades and a chain extending from the first sprocket wheel to a second sprocket wheel. A third sprocket wheel may be directly connected to the second sprocket wheel and a second chain may extend from the third sprocket wheel to a fourth sprocket wheel. The fourth sprocket wheel may be directly connected to the generator.

The gear arrangement may be configured to provide a 30:1 gear ratio between the turbine blades and the generator.

It will be appreciated by the skilled person that other suitable gear arrangements can be used to provide the desired gear ratio.

In a further embodiment, the electricity generating apparatus may comprise a magnetic generator, which may comprise magnetically geared generator. The magnetic generator may comprise a magnetic gearing arrangement and a winding arrangement comprising at least one coil of an electrical conductor.

The magnetic gearing arrangement may comprise a first magnet assembly and a second magnet assembly movable relative to each other. The winding arrangement may be arranged to interact magnetically with the first magnet assembly and/or the second magnet assembly to generate electrical power.

The first magnet assembly may be an inner magnet assembly. The first magnet assembly may be substantially cylindrical. The first magnet assembly may comprise a plurality of first magnets, which may be first permanent magnets. The first magnet assembly may comprise a first carrier carrying the first magnets.

The first magnet assembly may be rotatable about an axis. The first magnet assembly may comprise a first rotor. The winding arrangement may be disposed outwardly relative to the first magnet assembly.

The magnetic gearing arrangement may comprise an interference assembly to interfere with the magnetic fields of the first and second magnet assemblies so that said magnetic fields couple with each other. The interference assembly may be disposed between the first and second magnet assemblies. Thus, the interference of the interference assembly with the magnetic fields allows rotation of one of the first and second magnet assemblies to generate electricity in the winding arrangement.

The interference assembly may be movable. In one embodiment, the interference assembly may be rotatable about the axis. The interference assembly may be cylindrical. The interference assembly may comprise a plurality of pole pieces, which may be spaced substantially uniformly relative to each other.

The second magnet assembly may be an outer magnet assembly. The second magnet assembly may be substantially cylindrical. The second magnet assembly may comprise a plurality of second magnets, which may be second permanent magnets. The second magnet assembly may comprise a second carrier carrying the second magnets.

In one embodiment, the second magnet assembly may be rotatable about the axis. In this embodiment, the second magnet assembly may comprise a second rotor.

In an alternative embodiment, the second magnet assembly may be fixed. The second magnet assembly may comprise a stator.

The winding arrangement may be fixed. The winding arrangement may be cylindrical. The winding arrangement may be disposed outwardly of the second magnet assembly. The winding arrangement may extend around the second magnet assembly.

Alternatively, where the second magnet assembly is fixed, the winding arrangement and the second magnet assembly may be in the form of a single unit.

In the embodiments described herein, the turbine blades rotate at substantially 50 revolutions per minute.

The diameter of the turbine blade assembly may be between 1 and 6 metres, desirably between 1.5 and 5 metres, more desirably between 2 and 4 metres. The diameter of the turbine blade assembly may be substantially 2 metres. Alternatively, diameter of the turbine blade assembly may be substantially 4 metres.

An embodiment of the invention will now be described by way of example only, with reference to the accompanying drawings, in which:

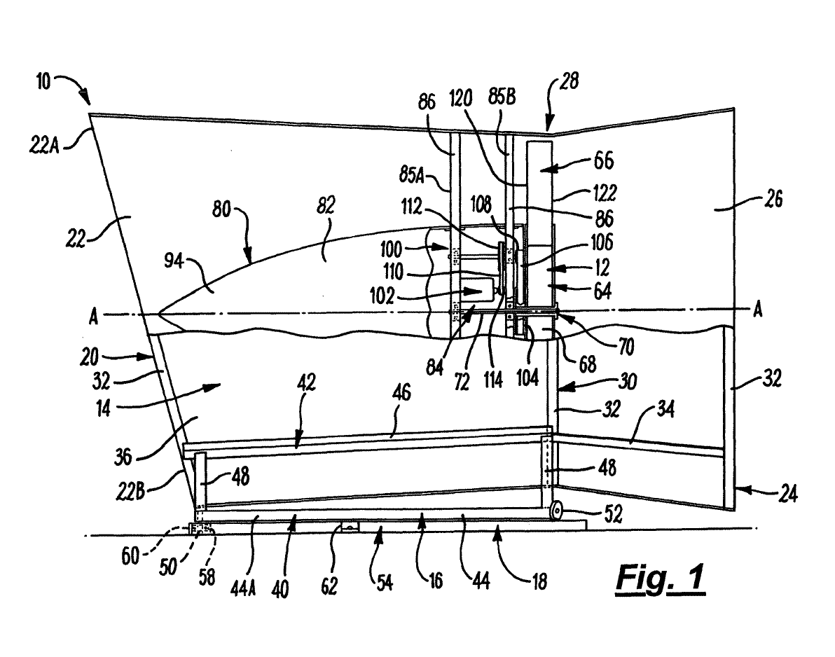

FIG. 1 is a part sectional view of an embodiment of a power generating apparatus;

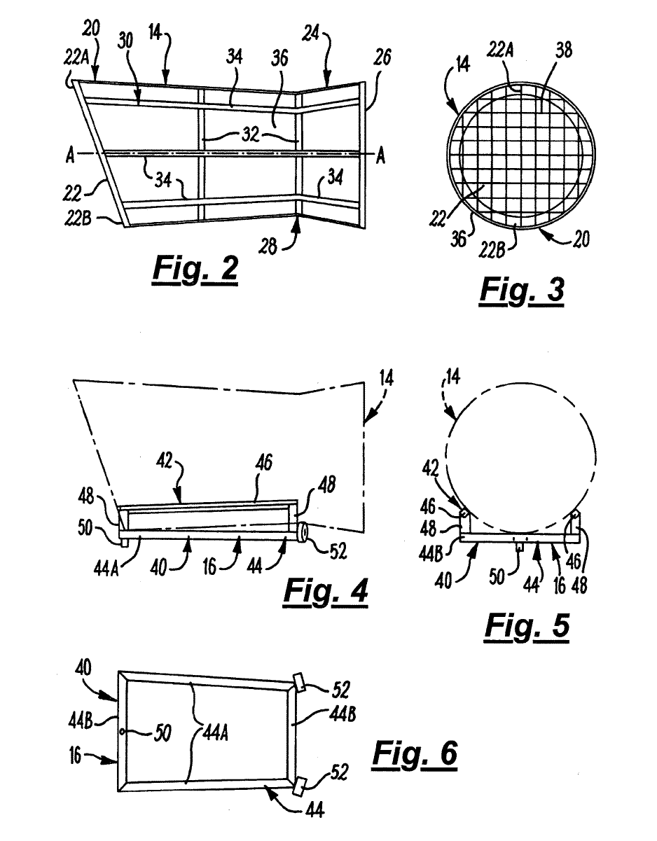

FIG. 2 is a side view of a housing being part of the power generating apparatus shown in FIG. 1;

FIG. 3 is an end view of the housing depicted in FIG. 2, showing an inlet opening;

FIG. 4 is a side view of a mounting frame being part of the power generating apparatus;

FIG. 5 is an end view of the mounting frame shown in FIG. 4;

FIG. 6 is a bottom view of the mounting frame shown in FIG. 4;

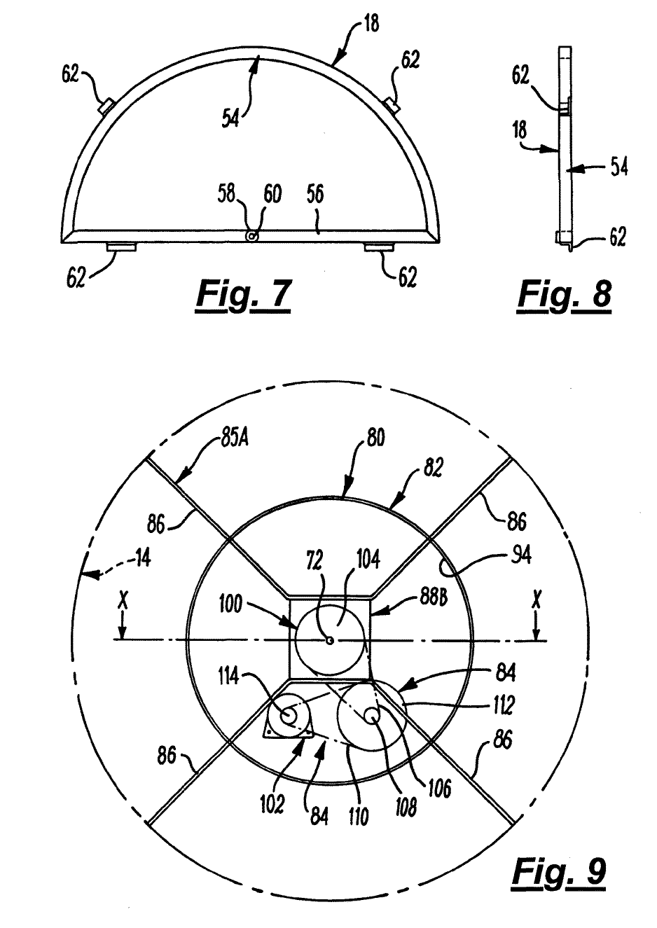

FIG. 7 is a top view of a base support structure, being part of the power generating apparatus;

FIG. 8 is a side view of the base support structure shown in FIG. 7;

FIG. 9 is an end view of a nose assembly being part of the power generating apparatus;

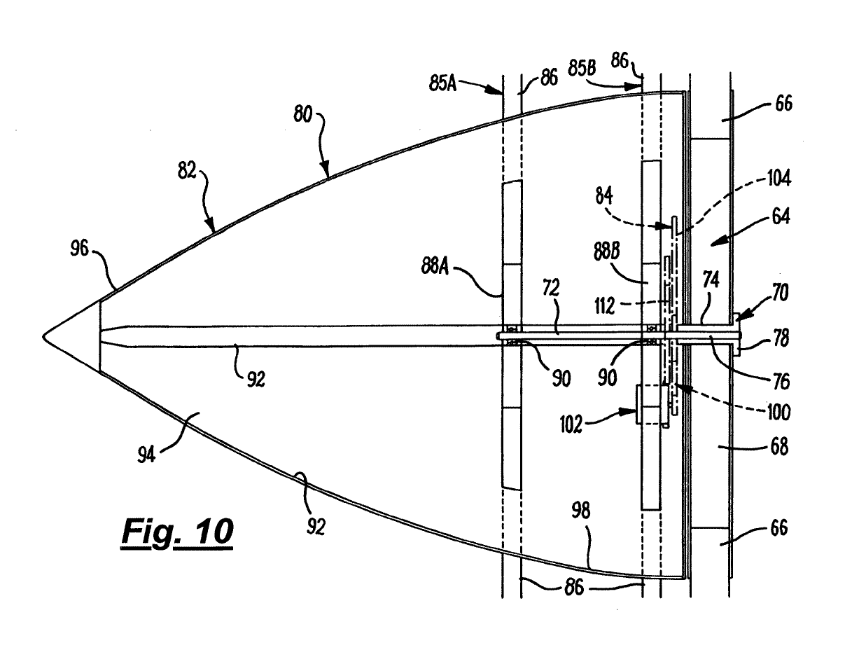

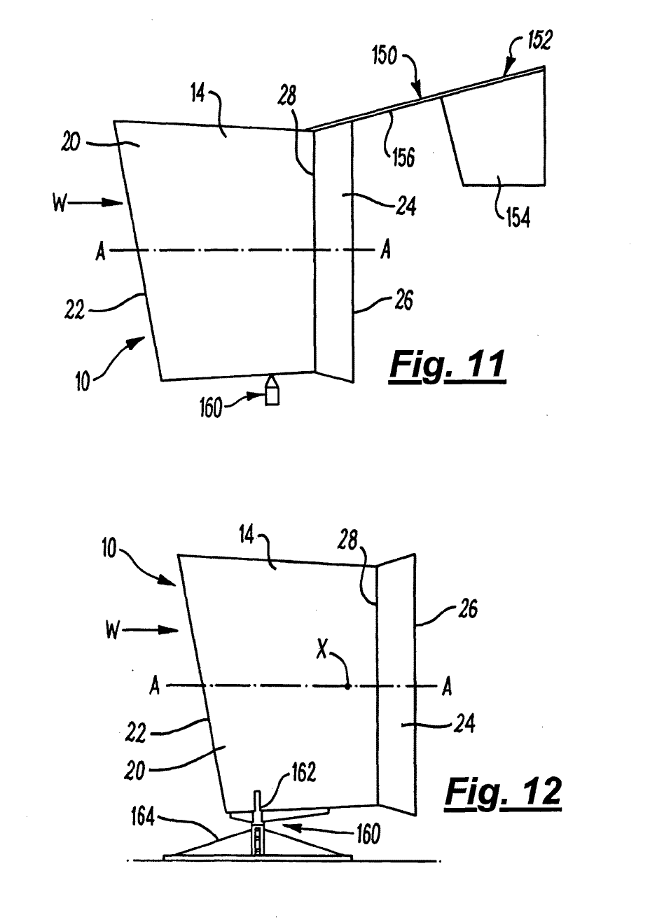

FIG. 10 is a view along the lines X-X in FIG. 9;

FIG. 11 is a side view of a further embodiment of the power generating apparatus;

FIG. 12 is yet another embodiment of a power generating apparatus;

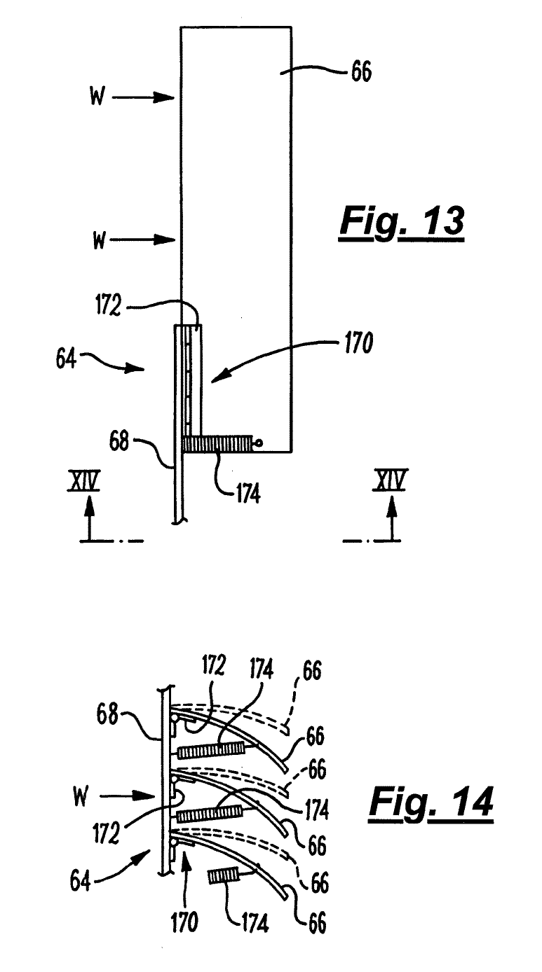

FIG. 13 is a side view of a turbine blade assembly, showing a single turbine blade;

FIG. 14 is a view along the lines XIV-XIV in FIG. 13;

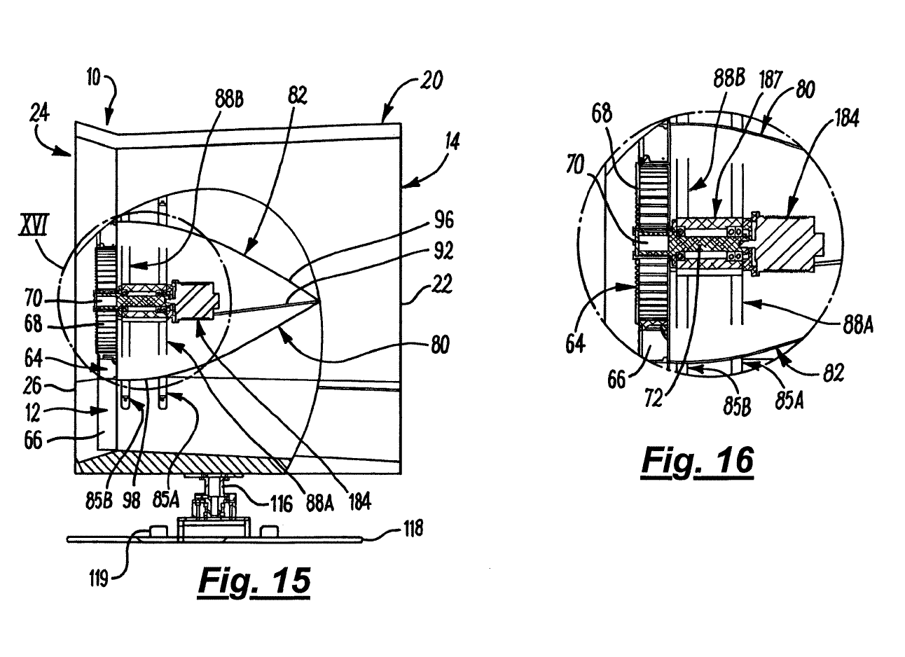

FIG. 15 is a side view of a further embodiment of the power generating apparatus showing a cut out region;

FIG. 16 is a close up view of the region marked XVI in FIG. 15;

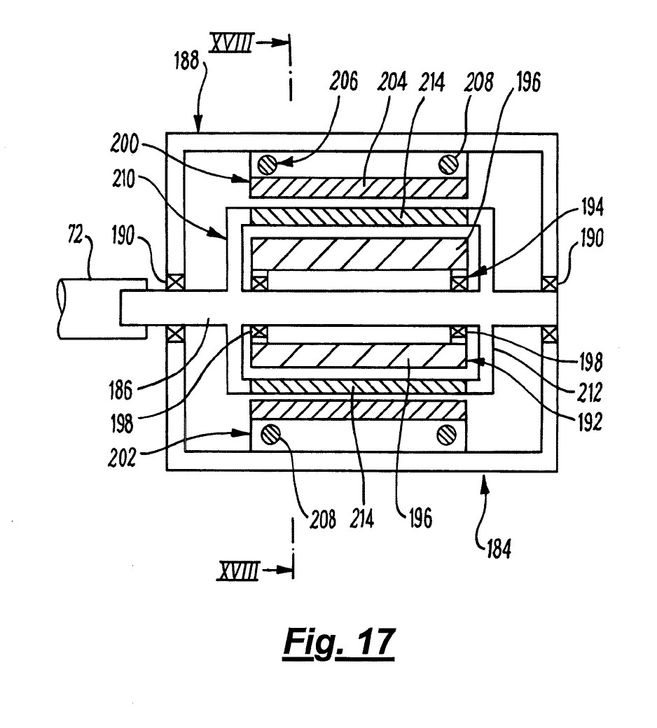

FIG. 17 is a sectional view of the generator used in the embodiment shown in FIG. 15; and

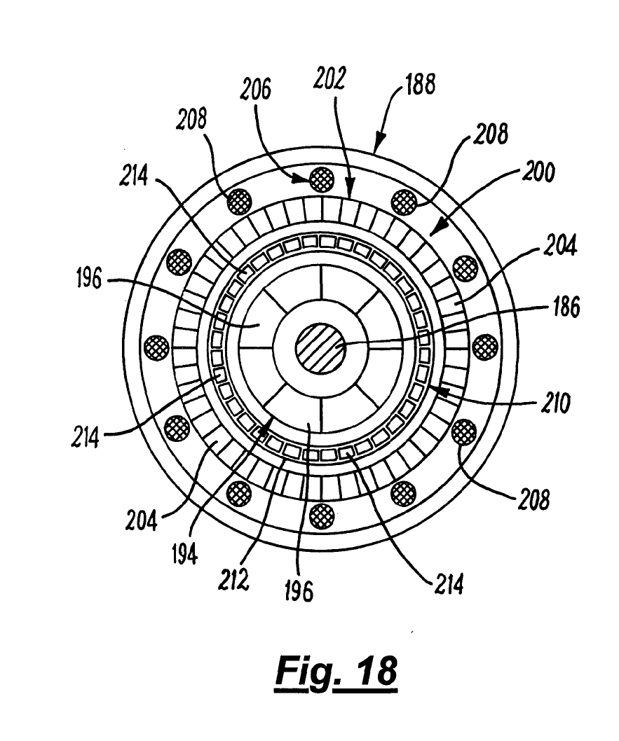

FIG. 18 is a view along the lines XVIII-XVIII in FIG. 17.

FIG. 1 of the drawings shows power generating apparatus 10, in the form of a wind turbine arrangement, which comprises a housing assembly comprising a wind turbine 12 housed within a housing 14. The power generating apparatus 10 further includes a mounting arrangement comprising a mounting frame 16 on which the housing 14 is mounted. The mounting frame 16 is pivotally connected to a base support structure 18 to allow the mounting frame 16 and the housing 14 to rotate and thereby face in the direction in which the wind is blowing.

Referring to FIGS. 2 and 3, the housing 14 has a forward region comprising an inlet portion 20 having an inlet opening 22. The housing 14 also has a rearward region comprising an outlet portion 24 having an outlet opening 26. A turbine holding region 28 is provided between the inlet portion 20 and the outlet portion 24.

The inlet portion 20 tapers inwardly from the inlet opening 22 to the turbine holding region 28. The outlet portion 24 tapers outwardly from the turbine holding region 28 to the outlet opening 26. This arrangement of the housing 14 has the effect that wind speed is increased from the inlet opening 22 towards the turbine holding region 28. The outward tapering of the outlet portion 24 creates a drop in pressure to increase airflow and turbine efficiency through the wind turbine 12.

The housing 14 comprises a skeletal frame 30 comprising a plurality of annular elements 32 connected by elongate elements 34. A skin 36 of a plastics material or of aluminum extends around the inside of the frame 30.

The housing has a main axis A-A and the inlet opening 22 is angled at an acute angle relative to the main axis A-A. As a result of the angled inlet opening, an upper region 22A of the inlet opening 22 extends forwardly of a lower region 22B, thereby helping to shield the inside of the housing 14 from rain and debris. A screen 38, in the form of a mesh (see FIG. 3), is provided over the inlet opening 22 to help prevent ingress by debris and wildlife.

The mounting frame 16 is shown in FIGS. 4 to 6 and comprises a lower frame section 40 and an upper frame section 42. The housing 14 (shown in broken lines in FIGS. 4 to 6) is seated on the mounting frame 16 with the annular members 32 engaging the upper frame section 42 and the lower frame section 40.

The lower frame section 40 may comprise plurality of elongate frame members 44. In the embodiment shown, the frame section comprises four elongate frame members 44 arranged in the shape of a regular trapezium.

As can be seen from FIG. 6, the plurality of elongate frame members 44 comprise a pair of opposite first frame members 44A and a pair of opposite second frame members 44B extending between the first frame members 44A. The upper frame section 42 comprises a pair of elongate support members 46 connected to, and spaced above, the first frame members 44A by spacer member 48 disposed at opposite ends of the elongate support members 46.

The first frame members 44A and the support members 46 are angled to correspond to the tapering shape of the inlet portion 20.

The mounting frame 16 further includes a pivot arrangement comprising a downwardly extending pivot member 50 on the lower frame section 44. The mounting frame 16 also includes a pair of rollers, in the form of wheels 52, on the lower frame section 44. As can be seen from FIGS. 5 and 6, the pivot member 50 is provided on one of the second frame members 44B and extends downwardly therefrom. The wheels 52 are rotatably mounted on the other of the second frame members 44B at an acute angle thereto. The angle of the wheels 52 corresponds to the curvature of a rail in which the wheels 52 roll. The purpose of the pivot member 50 and the wheels 52 is described below.

Referring to FIGS. 7 and 8, the mounting frame 16 is disposed on a base support structure 18 which comprises a semi circular rail 54 in which the wheels 52 are constrained. An elongate co-operating member 56 extends between the opposite ends of the semi circular rail 54 and defines an aperture 58 in which the pivot member 50 is received. A suitable bearing 60 is provided in the aperture 58 to engage the pivot member 50 and allow free rotation of the mounting frame 16.

The rail 54 and the co-operating member 56 are provided with securing members 62 for securing the base support structure 18 to a surface. The securing members 62 may be in the form of lugs through which fasteners such as bolts can be inserted.

In use, the base support structure 18 is disposed on a substantially horizontal surface, for example a flat roof of a building, and secured thereto by the use of bolts through the securing members 62, in a manner that would be understood by anyone skilled in the art.

The mounting frame 16 is arranged on the base support structure 18 so that the pivot member 50 is received in the aperture 58 and the wheels 52 engage the rail 54. The mounting frame 16 can pivot about the pivot member 50 through substantially 180°, with the wheels 52 travelling along the rail 54. Suitable driver, such as described below in connection with FIGS. 11 and 12, may be provided to drive the rotation of the mounting frame 16 along the rail 54 to ensure that the inlet opening 22 of the housing 14 faces the direction in which the wind is blowing.

Referring to FIGS. 9 and 10, the wind turbine 12 comprises a turbine blade assembly 64 comprising a plurality of turbine blades 66 mounted on, and extending radially from, a hub 68. In the embodiment shown, the turbine blade assembly 64 comprises 48 turbine blades 66 spaced circumferentially from each other about the hub 68. The hub 68 includes a central connecting member 70, which connects the hub 68 to a shaft 72.

The connecting member 70 has a first attaching portion 74 defining a bore 76 through which the shaft 72 extends. The shaft 72 is fixedly attached to the connecting member 70 in the bore 76. The connecting member 70 also includes a radially outwardly extending second attaching portion 78 for fixedly attaching the connecting member 70 to the hub 68.

As shown in FIG. 10, the wind turbine 12 also includes a nose assembly 80 comprising a nose cone 82 and an electricity generating apparatus 84. The shaft 72 extends from the turbine blade assembly 64 upstream therefrom into the nose cone 82. Two sets 85A, 85B of four elongate members in the form of braces 86 extend from the skeletal frame 30 of the housing 14 to respective rectangular holders 88A, 88B. The shaft 72 extends through the holders 88A, 88B, and bearings 90 are provided to allow rotation of the shaft 72 relative to the holders 88A, 88B.

The nose cone 82 comprises a frame of four elongate stays 92 which are attached to the two sets 85A, 85B of the braces 86. Thus, the nose cone 82 is attached to the housing 14 and does not rotate. A skin 94 of a suitable plastics material is disposed over the strut members 92.

The nose cone 82 has a tip region 96 and a base region 98. The skin 94 of the nose cone 82 is curved at a steeper angle at the tip region 96 than at the base region 98. This allows air to flow smoothly across the nose cone 82. The diameter of the nose cone 82 at the base is substantially 50% of the diameter of the turbine blade assembly 64.

The electricity generating apparatus 84 comprises a gearing arrangement 100 and an alternator 102. The alternator 102 is configured to be driven at substantially 1500 rpm to generate electricity and the turbine blade assembly 64 is configured to rotate at substantially 50 rpm. The gearing arrangement 102 therefore provides a gear ratio of substantially 30:1 to provide the required speed of rotation of the alternator 102.

In the embodiment shown, the gearing arrangement 100 comprises a first sprocket wheel 104 mounted directly on the turbine blade assembly 64 and a first endless drive member 106, which may be a first chain or toothed belt, extends to a second sprocket wheel 108. A third sprocket wheel 112 is fixedly mounted on the second sprocket wheel 108 and a second endless drive member 110, which may be a second chain or toothed belt extends from the third sprocket wheel 112 to a fourth sprocket wheel 114.

In FIG. 1, the endless drive members 106, 110 are shown as toothed belts. Suitable toothed belts for use in the embodiment described herein are timing belts. It will be appreciated that the first and second endless drive members 106, 110 could be chains, such as bicycle chains.

The fourth sprocket wheel 114 is directly mounted on the alternator 102 to drive the alternator 102. The sizes of the first, second, third and fourth sprocket wheels 104, 108, 112, 114 can be easily calculated by the person skilled in the art to obtain the required gear ratio.

The diameter of the turbine blade assembly 64 may be between 2 and 4 metres. In one embodiment, the diameter of the turbine blade assembly 64 is substantially 2 metres. Alternatively, the diameter of the turbine blade assembly 64 is substantially 4 metres. The diameter of the turbine blade assembly is slightly less than the diameter of the housing 14 at the turbine holding region 28. A gap is, therefore, defined between the tips of the turbine blades 66 and the housing 14 to allow free flow of air therebetween.

Referring to FIG. 1, each blade 66 has a leading edge 120, and a trailing edge 122. The pitch of each blade 66 at the leading edge 120 is substantially 0°. The pitch of each blade 66 at the trailing edge 122 is substantially 57°. The width of each blade 66 is substantially 150 mm.

Various modifications can be made without departing from the scope of the invention. For example, the lower frame section 40 may be substantially rectangular. In a further modification, the mounting frame 16 and the base support structure 18 could be replaced by a pylon or pole on which the wind turbine 12 and the housing 14 are rotatably mounted on a suitable drive arrangement to allow the wind turbine 12 and the housing 14 to face into the wind.

Further modifications are shown in FIGS. 11 to 14.

FIG. 11 shows an embodiment of the power generating apparatus 10, which includes driver 150 mounted on the housing 14. The driver 150 drives the rotation of the housing 14 so that the inlet opening 22 faces into the wind. In FIG. 11, the driver 150 comprises a vane arrangement 152 extending rearwardly from the housing 14. The vane arrangement 152 comprises a vane 154 and a connecting member 156 to connect the vane 154 to the housing 14.

The housing 14 is mounted on a pivot arrangement 160, which is shown diagrammatically in FIG. 11. The driver 150 causes the housing 14 to pivot about the pivot arrangement 160.

Wind blowing in the direction of the arrow W in FIG. 11 pushes the vane 154 to orient the housing 14 to the position shown in FIG. 11, thereby moving the inlet opening 22 to face into the wind W.

FIG. 12 shows a further example of Power generating apparatus 10, which is the similar to the embodiment shown in FIG. 11, differing in that the driver 150 comprises a pivot arrangement 160 mounted on the housing forwardly of the centre of gravity X of the housing 14. The pivot arrangement 160 comprises a pivot member 162 attached to the housing, and a support 164 on which the pivot member 162 is pivotally mounted.

Wind blowing in the direction of the arrow W in FIG. 12 applies a greater force to the region of the housing 14 rearwards of the pivot member than to the region of the housing forwards of the pivot member. As a result, the force of the wind pushes the housing 14 to orient it in the position shown in FIG. 12, thereby moving the inlet opening 22 to face into the wind W.

It will be appreciated that either of the drivers 150 shown in FIGS. 11 and 12 could be used in the power generating apparatus 10 shown in FIG. 1.

FIGS. 13 and 14 show a pitch control arrangement 170 for controlling the pitch of the turbine blades 66. FIG. 13 shows one of the blades 66 of the turbine blade assembly 64. The pitch control arrangement 170 comprises a respective hinge 172 to attach each blade 66 to the hub 68. The pitch control arrangement 170 further includes urging arrangement in the form of plurality of tension springs 174, a respective tension spring 174 being attached between each blade 66 and the hub 168. It will be appreciated that the tension springs 174 could be replaced by other types of spring, such as compressions springs by suitable modification of the turbine blade assembly 64.

In FIG. 14 shows the blades 66 in solid lines in a first position, being of a desired pitch, i.e. an angle of attack of the blades, at which maximum energy is extracted from the wind. The blades 66 are pivotally movable about the respective hinges 172 between the first position, shown in solid lines in FIG. 14, towards a second position shown in broken lines in FIG. 14, the second position being a position of minimum pitch, the blades 66 being moved from the first position towards the second position when the wind speed exceeds a predetermined first wind speed. When the wind speed reaches a predetermined second wind speed, the blades 66 are moved to the second position, and thereby reside in the second position. In the second position, the force on each of the blades 66 by the wind is minimised, thereby minimising the risk of damage in high winds. At wind speeds between the first and second wind speeds, the blades 66 are moved to an intermediate position between the first and second positions.

The blades 66 are urged to the first position by the springs 174, which apply a predetermined urging force to the blades 66. As the speed of the wind W increases, the force on the blades 66 from the wind W also increases. When the force of the wind W on the blades exceeds the urging force applied by the springs 174, i.e. at a predetermined first wind speed, the blades 66 pivot from the first position, shown in solid lines in FIG. 14 towards the second position, shown in broken lines in FIG. 14, thereby reducing the force on the blades.

Thus, the higher the wind speed, the greater the degree to which the blades 66 are pivoted about the hinges 172 towards the second position. At very high wind speeds, the blades 66 are pivoted to the second position and little or no energy is extracted from the wind. As the wind speed increases above the aforementioned first wind speed, the efficiency of the blades 66 in extracting energy form the wind gradually reduces to prevent the wind turbine 12 from rotating too fast. Desirably, the wind turbine rotates at a constant speed for all wind speeds above 40 mph.

A further embodiment is shown in FIGS. 15 to 18. The power generating apparatus 10 shown in FIGS. 15 to 18 comprises many of the features shown in FIGS. 1 to 14. Those features in FIGS. 15 to 18 have been designated with the same reference numerals as the corresponding features in FIGS. 1 to 14.

The power generating apparatus 10 shown in FIGS. 15 to 18 differs from the embodiment shown in FIGS. 1 to 14 in that the mounting frame 16 and base support structure 18 are replaced a shaft 116 rotatably mounted on a support 118, which can be secured to, for example, the roof of a building, by fasteners, which may be in the form of bolts 119. A further difference is that the electricity generating apparatus 84 is in the form of a magnetically geared generator 184.

The magnetically geared generator 184 comprises an axle 186 mounted on the shaft 72 (see FIG. 17), and rotates therewith when the shaft 72 is rotated by the turbine blades 66. In the embodiment shown in FIGS. 15 to 18, the shaft 72 is housed within a housing 187 fixedly attached to the holders 88A, 88B.

The axle 186 extends through a casing 188 and is rotatably mounted thereon by bearings 190. The casing 188 is fixedly attached to the housing 187 and therefore cannot rotate.

The magnetically geared generator 184 further comprises a first rotor in the form of a first magnet assembly 192. In the embodiment shown, the first magnet assembly 192 comprises a first annular carrier 194 and a plurality of first permanent magnets 196 arranged in a circular array around the first annular carrier 194. The first carrier 194 is rotatably mounted on the axle 186 by bearings 198, thereby allowing the first magnet assembly 192 to rotate relative to the axle 186.

The magnetically geared generator 184 further includes a stator in the form of a second magnet assembly 200 fixedly mounted on the casing 188. The second magnet assembly 200 comprises a second annular carrier 202 and a plurality of second permanent magnets 204 arranged in a circular array around the second annular carrier 202. The second annular carrier 202 is concentric with the first annular carrier 194, whereby the second magnet assembly 200 is concentric with the first magnet assembly 192.

The magnetically geared generator 184 further includes a winding arrangement 206 carried by the second carrier 202. The winding arrangement 206 is disposed outwardly relative to the second magnet assembly 200. The winding arrangement 206 comprises a plurality of coils 208 of an electrical conductor arranged in a circular array around the second annular carrier 202. The winding arrangement 206 is concentric with the second magnet assembly 200.

The magnetically geared generator 184 also includes a second rotor in the form of an interference assembly 210 disposed between the first and second magnet assemblies 192, 200. The interference assembly 210 comprises an annular support 212 fixedly mounted on the axle 186, whereby, the interference assembly 210 is rotated by the rotation of the axle 186.

The interference assembly 210 further includes a plurality of pole pieces 214 on the annular support 212. The pole pieces 214 are arranged in a circular array around the annular support 212. Each pole piece 214 comprises an elongate member formed of a material of high magnetic permeability, such as steel.

In operation, when the blades assembly 64 is rotated by the wind, the axle 186 is rotated. In view of the presence of the second magnet assembly 200, the rotation of the pole pieces 214 causes the first magnet assembly 192 to rotate. The pole pieces 214 interfere with the magnetic fields of the first and second permanent magnets 196, 204 to cause the magnetic fields to couple with each other and produce torque to rotate the first magnet assembly 192.

The coils 208 magnetically couple with the magnetic fields thereby inducing a voltage in the electrical conductors forming the coils 208. The electricity so generated can be passed to suitable means for connection to the electricity grid or for direct use in a manner that would be known to the person skilled in the art.

Various modifications can be made without departing from the scope of the invention.

1-49. (canceled)

50. Power generating apparatus comprising: a housing; a wind turbine within the housing, the wind turbine comprising a plurality of rotatable turbine blades, wherein the housing has a forward region extending forwardly of the wind turbine, the forward region defining an inlet for air, and a rearward region extending rearwardly of the wind turbine, the rearward region defining an outlet for air; a support arrangement for supporting the wind turbine on the housing, wherein the support arrangement includes a nose cone arranged forwardly of the wind turbine; and an electricity generating apparatus arranged inside the nose cone forwardly of the wind turbine.

51. Power generating apparatus according to claim 50, wherein the wind turbine includes a hub to which the plurality of turbine blades are attached, the turbine blades extending radially from the hub, and wherein the hub has a principal axis about which the turbine blades can rotate, and the wind turbine comprises between 40 and 56 turbine blades spaced regularly about the hub.

52. Power generating apparatus according to claim 51, wherein each turbine blade has a leading edge and a trailing edge, and the pitch of each turbine blade increases from the leading edge to the trailing edge, the pitch of the leading edge of each turbine blade being between 0° and 10°, and the pitch of the trailing edge of each turbine blade being between 50° and 60°.

53. Power generating apparatus according to claim 52, wherein the wind turbine comprises a pitch control arrangement for controlling the pitch of the turbine blades, the pitch control arrangement comprising a hinge arrangement for providing hinged attachment of each turbine blade to the hub and an urging arrangement for urging the turbine blades to a first position of a desired pitch, the urging arrangement being configured to apply an urging force onto the turbine blades, whereby when the force of the wind on the turbine blades exceeds said urging force, the turbine blades move towards a second position, being a position of minimum pitch of the turbine blades.

54. Power generating apparatus according to claim 50, including a mounting arrangement for supporting the housing, wherein the mounting arrangement includes a pivot arrangement about which the housing can revolve, and the power generating apparatus comprises a driver for revolving the housing, the driver comprising a wind reactive arrangement being reactive to the force of the wind thereon.

55. Power generating apparatus according to claim 50, wherein the electricity generating apparatus is in the form of a magnetically geared generator comprising a magnetic gearing arrangement and a winding arrangement comprising at least one coil of an electrical conductor the magnetic gearing arrangement comprising a first magnet assembly and a second magnet assembly movable relative to each other, and the winding arrangement being arranged to interact magnetically with the first magnet assembly and/or the second magnet assembly to generate electrical power.

56. Power generating apparatus according to claim 55, wherein the magnetic gearing arrangement further comprises an interference assembly to interfere with the magnetic fields of the first and second magnet assemblies so that said magnetic fields couple with each other, the interference assembly being arranged about an axis between the first and second magnet assemblies.

57. Power generating apparatus according to claim 56, wherein the interference assembly is movable relative to the first and second magnet assemblies.

58. Power generating apparatus according to claim 57, wherein the interference assembly is cylindrical and is rotatable about the axis.

59. Power generating apparatus according to claim 58, wherein the interference assembly comprises a plurality of pole pieces spaced substantially uniformly relative to each other.

60. Power generating apparatus according to claim 56, wherein the interference assembly is provided between the first and second magnet assemblies.

61. Power generating apparatus according to claim 56, wherein the first magnet assembly is an inner magnet assembly and the second magnet assembly is an outer magnet assembly.

62. Power generating apparatus according to claim 61, wherein the first magnet assembly is substantially cylindrical and comprises a plurality of first magnets, and wherein the first magnet assembly comprises a first carrier carrying the first magnets, and wherein the second magnet assembly is substantially cylindrical and comprises a plurality of second magnets, and wherein the second magnet assembly comprises a second carrier carrying the second magnets.

63. Power generating apparatus according to claim 62, wherein the first magnets comprise first permanent magnets, and the second magnets comprise second permanent magnets.

64. Power generating apparatus according to claim 56, wherein the first magnet assembly is rotatable about said axis, and the winding arrangement is disposed radially outwardly relative to the first magnet assembly.

65. Power generating apparatus according to claim 56, wherein the second magnet assembly is rotatable about the axis.

66. Power generating apparatus according to claim 56, wherein the second magnet assembly is fixed.

67. Power generating apparatus according to claim 56, wherein the second magnet assembly is provided radially outwardly of the first magnet assembly.

68. Power generating apparatus according to claim 56, wherein the winding arrangement is fixed, and is of a cylindrical configuration.

69. Power generating apparatus according to claim 56, wherein the winding arrangement is disposed outwardly of the second magnet assembly, and extends around the second magnet assembly.
